(19) United States
(12) Patent Application Publication
(10) Pub. No.: US 2026/0026650 A1
(43) Pub. Date: Jan. 29, 2026

(54) Two Minute Pizza Oven With Multi-Circuit Toaster Board Heating Element

(71) Applicant: Michael Weinberger, Metairie, LA (US)

(72) Inventor: Michael Weinberger, Metairie, LA (US)

(21) Appl. No.: 19/037,031

(22) Filed: Jan. 24, 2025

Related U.S. Application Data
(60) Provisional application No. 63/625,900, filed on Jan. 26, 2024.

(51) Int. Cl. A47J 37/06

(52) U.S. Cl. CPC A47J 37/0658; A47J 37/0629

(57) ABSTRACT

A device for cooking pizza in about two minutes is disclosed. The device may comprise an internal cooking chamber, a first heating element affixed to the bottom wall of the chamber, a second heating element affixed to the top wall of the chamber, and a holder member parallel to the top and bottom walls upon which the pizza is placed. Each heating element may include one or more lengths of exposed high-resistance conductor that produce wattages when current is applied across two or more terminals to which the high-resistance wires are affixed. The heating elements are configured to produce a total combined wattage of about 3 to 4 watts per cubic inch of volume of the internal cooking chamber.

### CROSS-REFERENCES TO RELATED INVENTIONS

This application claims the benefit of prior filed provisional application 63/625,900, Confirmation Number 4498, entitled “2 Minute Pizza Oven,” filed on Jan. 26, 2024, and prior filed provisional application 63/739,667, Confirmation Number 1265, entitled “Multiple Circuit Toaster Board,” filed on Dec. 29, 2024.

### FIELD OF THE INVENTION

The present invention is generally related to a 120-volt electric oven used for cooking pizzas, and to a multi-circuit heating element, called here a “multiple circuit toaster board,” that may be used in 120 volt electric ovens.

### STATEMENTS AS TO THE RIGHTS TO INVENTIONS MADE UNDER FEDERALLY SPONSORED RESEARCH OR DEVELOPMENT

Not applicable.

### REFERENCE TO A “SEQUENCE LISTING,” A TABLE, OR A COMPUTER PROGRAM LISTING APPENDIX SUBMITTED ON A COMPACT DISK

Not applicable.

### BACKGROUND OF THE INVENTION—ELECTRIC OVENS

Some people want their food fast, as fast-food restaurants and instant oatmeal prove. And some people want homemade pizza fast. To cook pizza quickly, companies like Boboili, Golden Home, and Mama Mary's sell partially baked (“par-baked”) pizza crusts. As explained by Hourancy in U.S. Pat. No. 6,063,413, completing the cooking process of par-baked dough, called “finishing,” is faster than cooking raw dough.

Although cooking with par-baked dough is faster than cooking with raw dough, no 120-volt electric oven can finish a par-baked crust, melt the cheese and produce a pizza in two to three minutes. There are several reasons for this. One reason is because many ovens use heating elements that need to warm up before they can cook food. Such pre-heating can take up to twenty-six minutes, as indicated, for example, on page 9 of the manual for the Chefman Home Slice Pizza Oven, a currently available 120-volt electric oven. Another reason is that many ovens have a low wattage to internal volume ratio, as explained subsequently in this application.

Many 120-volt electric ovens, toaster ovens, and pizza ovens exist in the prior art. In general, they consist of an exterior housing and an interior cooking chamber, as shown by Ingemanson in U.S. Pat. No. 6,670,586 B2. Some of these ovens use heating element conductors consisting of exposed high-resistance electrical wire, such as nichrome wire, as discussed by Schall in U.S. Pat. No. 3,196,243. This wire is often found in toasters and can get red hot in two to three seconds. Other ovens use conductors consisting of high-resistance wire covered in a steel sheathing, commonly called a “Calrod,” as discussed by Li in U.S. Pat. No. 7,973,264 B2, or quartz heaters, as discussed by Mograbi in U.S. Pat. No. 8,929,724 B1. Calrods and quartz heaters, however, take much longer to get red hot than fast heating exposed high-resistance wire.

As for position of the pizza inside the oven, in some existing devices, the pizza may be placed on a wire rack, as shown by Forkner in US Application 2007/0227365 A1. In others the pizza is placed on a metal screen commonly called a “pizza screen,” as discussed by Lopresti, et al, in U.S. Pat. No. 6,626,091 B. And in other devices, the pizza may be placed on a ceramic surface called a “pizza stone,” as discussed by Borovicka in U.S. Pat. No. 11,076,718 B2.

Some existing ovens are “convection” style devices or “air fryers.” These speed the cooking process by circulating the hot air inside the oven, as discussed by Zimmer, et al in US Application 2010/0193507 A1 and Gilmartin in U.S. Pat. No. 11,457,768 B1. But even convection ovens and air fryers are not configured to cook a par-baked pizza in two to three minutes.

As explained by Magner in U.S. Pat. No. 9,962,037 B2, when applying heat to food in an enclosed chamber, the amount of heat, which can be measured as watts per cubic inch, needs to be calculated. Many prior art ovens have an enclosed cooking chamber to wattage ratio that is under 1.5 watts per cubic inch. For example, the Kratos 29M-004, Adcraft CK2 and Carnival King CPO12 are all 120-volt pizza ovens with about 1100 cubic inches of interior space and heating elements that produce 1450 watts of heat, a ratio of about 1.3 watts per cubic inch, which cannot cook a pizza in two to three minutes.

Rather, cooking a pizza in two to three minutes requires two things: a ratio of about 3 to 4 watts per cubic inch, as revealed in this application, and using a heating element, such as exposed nichrome wire, that gets red hot in about three to five seconds, as opposed to a Calrod or quartz heater, which takes much longer. It is therefore an object of the present invention to provide an electric oven that requires no pre-heating and can cook a thin par-baked pizza in two to three minutes.

### BACKGROUND OF THE INVENTION—TOASTER BOARDS

As discussed by Ireland in U.S. Pat. No. 2,012,788 many bread toasters use a type of heating element comprising of a nonflammable board, such as a silver-colored mica board, with a length of exposed high-resistance conductor, such as high-resistance wire, mounted to the board. When the wires are energized with electricity, they glow red hot and the “toaster board” toasts bread. Toaster boards are generally found in toasters, though may also be used as heating elements elsewhere, such as in electric ovens.

There are many types of toaster boards. While some consume 400 watts, others may consume more or less. Some have exposed high-resistance wire conductor on both sides of the board to allow both sides to toast a separate slice of bread, while others have exposed high-resistance wire on only one side. For the wire conductor material, some use small flat bands of nichrome metal, as opposed to nichrome in a traditional wire shape. Multiple wire configurations are available in the prior art. For example, Feldman, et all, in U.S. Pat. No. 10,842,318 B2, in the third paragraph of his Summary, discloses a toaster board with an exposed conductor in a “zig zag” configuration.

All currently available toaster boards known to this inventor, however, comprise of one continuous length of exposed high-resistance conductor with 2 electric terminals, with one terminal is at each end of the conductor. Hence, unless other electric controls are used, such as a rheostat, the single conductor on each board only produces a single level of heat when energized with 120-volts. For example, if a board contains a single length of exposed conductor that is 6 feet long, and the conductor generates 6 ohms of resistance per foot, that board will produce 36 ohms of resistance. When energized with 120-volts, such a board will produce 400 watts of heat, not more and not less.

No currently available toaster board known to this inventor comprises multiple lengths of exposed conductor and/or more than two terminals such that, for example, 6 feet of conductor can be energized to produce 400 watts, and/or 5 feet can be energized to produce 480 watts. It is therefore a further object of the present invention to disclose a toaster board which may be used in a 120 volt electric oven that comprises multiple lengths of exposed high-resistance conductor and/or more than two terminals on a single board, or on several boards attached to each other resulting in one “master board,” which single board or master board can produce different wattage levels without the use of a voltage regulator such as a rheostat.

### SUMMARY OF THE INVENTION

According to an exemplary embodiment of the present invention, a pizza oven may comprise a cooking chamber, a rack or screen, and a heating element. The heating element is comprised of a fast-heating conductor, such as exposed, high-resistance wire, wherein the wire may be positioned above and below a pizza inserted placed within the cooking chamber on the rack, and wherein the cooking chamber is configured to have an interior cooking chamber size to wattage ratio of about three to four watts per cubic inch. In some embodiments, the heating element may further comprise multiple lengths of exposed high-resistance conductor, and/or multiple terminals, on a single toaster board or on several boards attached to each other to create a “master board.” The toaster board may comprise of a single sheet of non-conductive, heat-resistant material, such as mica or similar material, or several sheets attached to create one master board. When different lengths of conductor on the toaster board or master board are energized, different levels of heat will be produced.

### BRIEF DESCRIPTION OF THE DRAWINGS

FIG. 1 is a top left perspective view of a pizza oven, accordingly to an exemplary embodiment of the present invention.

FIG. 2 is a bottom right perspective view of a heating element, according to an exemplary embodiment of the present invention.

FIG. 3 is a top view of a heating element, according to an exemplary embodiment of the present invention.

FIG. 4 is a top view of a heating element, accordingly to an exemplary embodiment of the present invention.

FIG. 5 is a top view of a heating element, according to an exemplary embodiment of the present invention.

FIG. 6 is a top view of a heating element, according to an exemplary embodiment of the present invention.

FIG. 7 is a top view of a heating element, according to an exemplary embodiment of the present invention.

### DETAILED DESCRIPTION

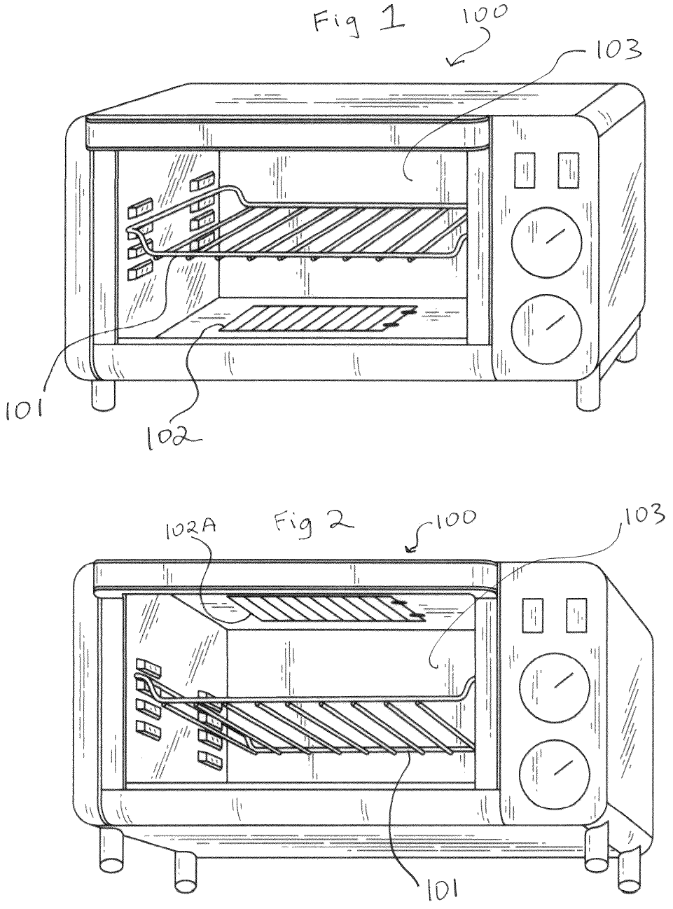

FIG. 1 shows a pizza oven 100 according to an exemplary embodiment of the present invention, having a wire rack 101 to hold a pizza, one embodiment of bottom heating element 102, and an internal cooking chamber 103 having top, bottom, left, right, front, and back walls.

FIG. 2 shows another view of pizza oven 100 having a wire rack 101 and one embodiment of top heating element 102A and internal cooking chamber 103 having top, bottom, left, right, front, and back walls.

According to an exemplary embodiment of the present invention, the total wattage supplied by top heating element 102 and bottom heating element 102 must equal about 3-4 watts per cubic inch of the internal chamber 103. For example, in an embodiment of the present invention wherein internal chamber 103 is 400 cubic inches, top and bottom heating elements 102 and 102A may be configured such that their total wattage is from 1200 to 1600 watts.

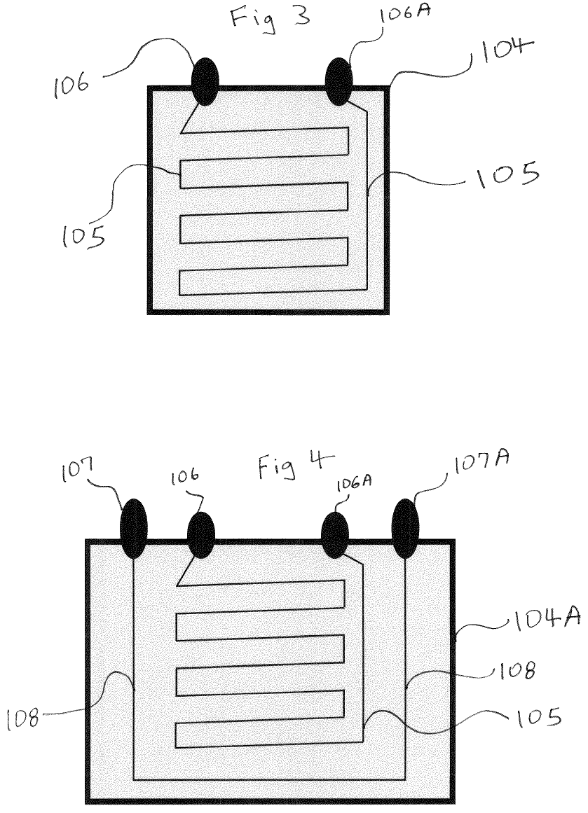

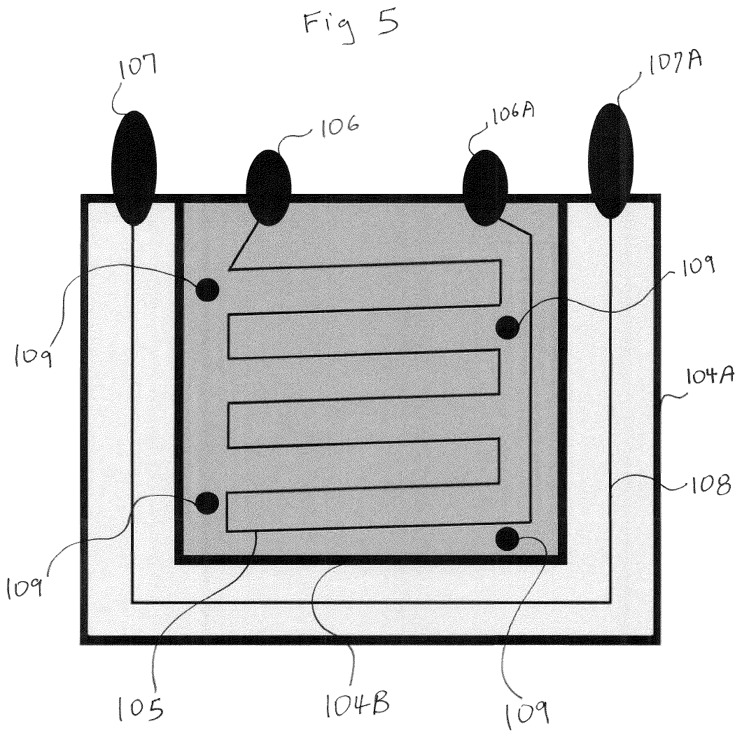

FIG. 3 shows one embodiment of heating elements 102 and 102A comprising of a non-conductive, heat-resistant board 104, one length of exposed high-resistance wire 105 and terminals 106 and 106A. In some embodiments of the present invention, exposed high-resistance wire 105 may comprise of any high-resistance wire known in the art, including a nichrome alloy that, in some embodiments, may comprise 80% nickel and 20% chromium, commonly called Nichrome 80 wire, or an iron-chromium-aluminium (FeCrAl) alloy.

FIG. 4 shows one embodiment of a multi-circuit heating element board comprising a non-conductive, heat-resistant board 104A, a first length of exposed high-resistance wire 105, terminals 106 and 106A, a second length of exposed high-resistance wire 108, and terminals 107 and 107A. In certain embodiments, wires 105 and 108 may be comprised of the same type of exposed high-resistance wire, such as Nichrome 80 in 26 gauge, or an iron-chromium-aluminium alloy. In such embodiments wherein first length 105 is not equal to second length 108, first length 105 and second length 108 are thus configured to produce different levels of resistance when energized. Accordingly, such embodiments are configured to produce different wattage levels, depending on which combination of terminals are energized: 106 and 106A, or 107 and 107A. Additionally, terminals 106A and 107A may be connected, which will produce yet a third wattage level when terminals 106 and 107 are energized.

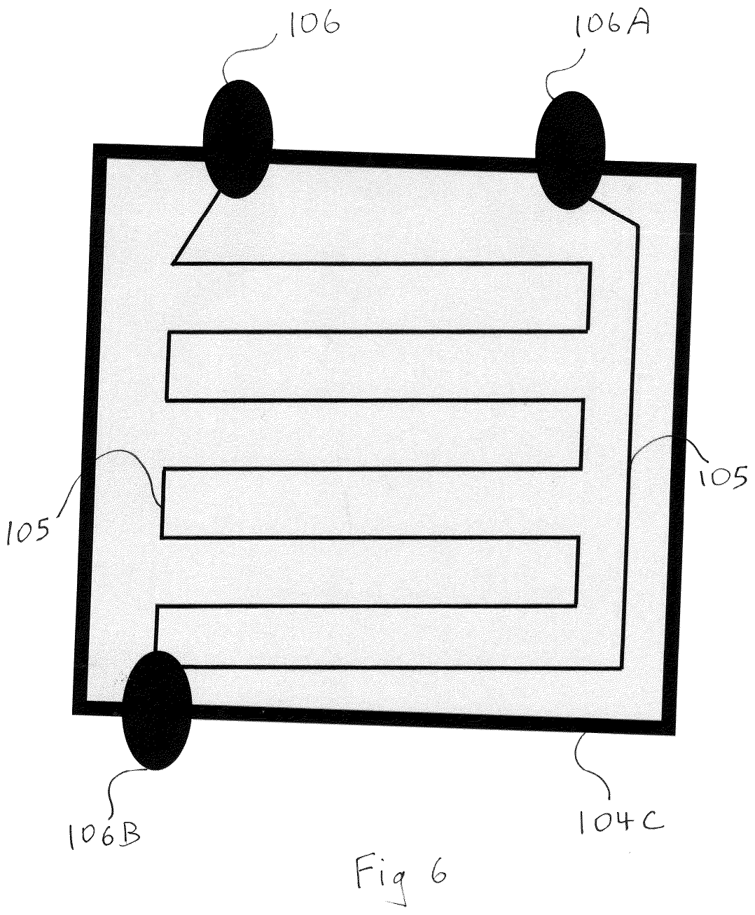

FIG. 5 shows one embodiment of a multi-circuit “master board” comprising of a large non-conductive, heat-resistant board 104A and a small non-conductive, heat-resistant board 104B. Small non-conductive, heat-resistant board 104B may be attached to large non-conductive, heat-resistant board 104A by fasteners 109. In some embodiments, fasteners 109 may be rivets, and the non-conductive, heat-resistant boards may be made of mica or similar material. The four terminals in FIG. 4 may be energized so as to produce different wattage levels. FIG. 5 may be energized or connected similar to the board shown in FIG. 4 so as to produce different wattage levels.

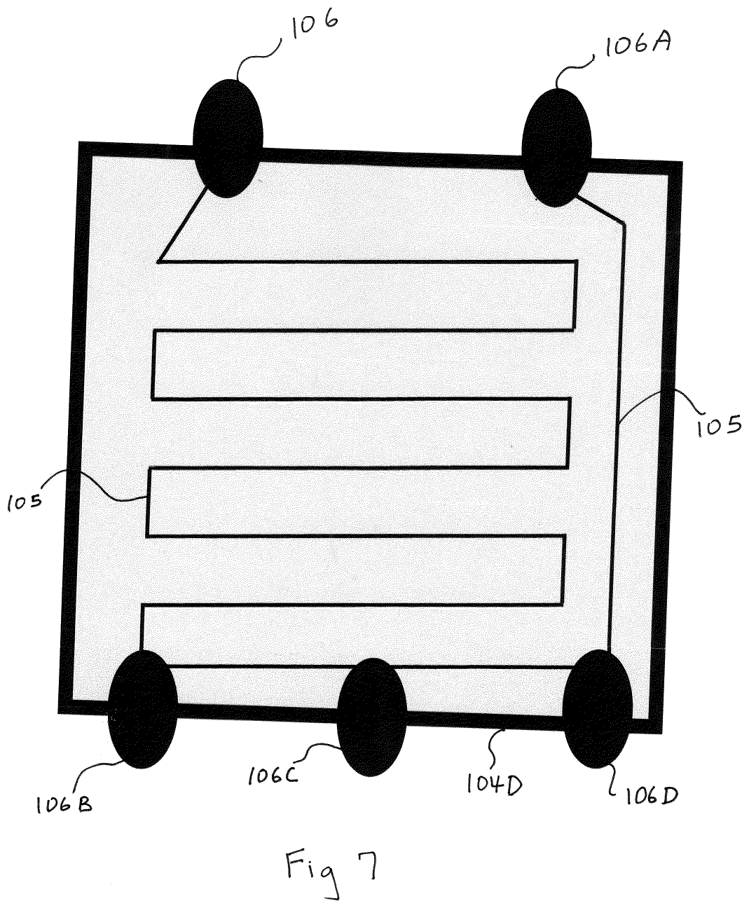

FIG. 6 shows one embodiment of heating elements 102 and 102A comprising a non-conductive, heat-resistant board 104C, one length of exposed high-resistance wire 105, terminals 106, 106A, and also potential terminal 106B placed between 106 and 106A. In this embodiment, one wattage level will be produced if terminals 106 and 106A are energized, and a different wattage level will be produced if terminal 106 and potential terminal 106B are energized. In some embodiments of the present invention, exposed high-resistance wire 105 may comprise any high-resistance wire known in the art, including a nichrome alloy that, in some embodiments, may comprise 80% nickel and 20% chromium, commonly called Nichrome 80 wire, or an iron-chromium-aluminum alloy. The addition of potential terminal 106B allows a device incorporating an embodiment of heating element(s) 102 or 102A as demonstrated in FIG. 6 to select between two separate wattages—and therefore two separate heat settings—depending upon which length of exposed high-resistance wire 105 is energized. For example, if a current is placed across terminal 106 and 106A, the full length of exposed high-resistance wire 105 is energized, thereby resulting in a lower wattage—and a lower heat—than if a current is placed across terminal 106 and potential terminal 106B, thereby energizing only a portion of exposed high-resistance wire 105.

FIG. 7 demonstrates an additional embodiment of heating elements 102 and 102A that incorporates four potential terminals 106B, 106C, 106D, and 106E. Accordingly, in some embodiments, a device incorporating an embodiment of heating element(s) 102 or 102A as demonstrated in FIG. 7 may incorporate a switch, such as a rotary switch, configured to select the portion of exposed high-resistance wire 105 that is energized. For example, a rotary switch having five settings (in addition to an “off” setting), may select between applying a current across terminal 106 and one of 106B, 106C, 106D, 106E, and 106A, respectively, with each selection corresponding to an increasingly long portion of exposed high-resistance wire 105. As the portion of exposed high-resistance wire 105 that is energized is lengthened (i.e., the switch is moved between supplying a current across terminal 106 and one of 106B, 106C, 106D, 106D, 106E, and 106A, respectively), the wattage produced by the energized portion of exposed high-resistance wire 105 decreases, and thus the heat produced decreases.

While the embodiments of the present invention are described herein with reference to various implementations and exploitations, it will be understood that these embodiments are illustrative and that the scope of the invention(s) is not limited to them. In general, embodiments of a pizza oven and/or heating element as described herein may be implemented using methods, facilities, devices, and materials consistent with any appropriate structure as described or illustrated herein. Many variations, modifications, additions, and improvements are possible.

For example, plural instances may be provided for components, operations, or structures described herein as a single instance. Boundaries between various components, operations, and functionality are depicted somewhat arbitrarily, and particular operations are illustrated within the context of specific illustrative configurations. In general, structures and actions presented as separate components or steps in the exemplary configurations may be implemented as a combined structure or step. Similarly, structures and actions presented as a single component or step may be implemented as separate components or steps. These and other variations, modifications, additions, and improvements may fall within the scope of the inventive subject matter.

What is claimed is:

1. A device for cooking pizza, comprising:
an internal chamber having a volume, a bottom wall, a top wall, a left wall, a right wall, a back wall, and a front wall;
a holder member configured to allow air to pass through the member horizontally positioned between the bottom wall and the top wall such that the holder member is parallel to the bottom wall and the top wall;
a first heating element affixed to the bottom wall; and
a second heating element affixed to the top wall,
wherein the first heating element and the second heating element are configured such that the total wattage produced by the combination of the first and second heating elements is about 3 to about 4 watts per cubic inch of the volume of the internal chamber.

2. The device of claim 1, wherein each of the first heating element and the second heating further comprise:
a non-conductive board;
a first terminal affixed to the non-conductive board;
a second terminal affixed to the non-conductive board; and
a length of fast heating, exposed high-resistance conductor having a first end and a second end,
wherein the first end of the length of fast heating, exposed high-resistance conductor is affixed to the first terminal;
wherein the second end of the length of fast heating, exposed high-resistance conductor is affixed to the second terminal; and
wherein the fast heating, exposed high-resistance conductor produces a wattage when a current is applied across the first and second terminals.

3. The device of claim 2, wherein the fast heating, exposed high-resistance conductor is comprised of one of an alloy containing about 80% nickel and 20% chromium or an iron-chromium-aluminum alloy.

4. The device of claim 1, wherein each of the first heating element and the second heating element further comprise:
a non-conductive board;
a first terminal affixed to the non-conductive board;
a second terminal affixed to the non-conductive board;
a first length of fast heating, exposed high-resistance conductor having a first end affixed to the first terminal and a second end affixed to the second terminal;
a third terminal affixed to the non-conductive board;
a fourth terminal affixed to the non-conductive board; and
a second length of fast heating, exposed high-resistance conductor having a first end affixed to the third terminal and a second end affixed to the fourth terminal,
wherein the length of the first length of fast heating, exposed high-resistance conductor is not equal to the length of the second length of fast heating, exposed high-resistance conductor;
wherein the first length of fast heating, exposed high-resistance conductor produces a first wattage when a current is applied across the first and second terminals; and
wherein the second length of fast heating, exposed high-resistance conductor produces a second wattage when the current is applied across the third and fourth terminals.

5. The device of claim 4, wherein each of the first and second lengths of fast heating, exposed high-resistance conductor comprises one of an alloy containing about 80% nickel and about 20% chromium or an iron-chromium-aluminum alloy.

6. The device of claim 1, wherein each of the first heating element and the second heating element further comprises:
a first non-conductive board;
a second non-conductive board affixed to the first non-conductive board;
a first terminal and a second terminal affixed to the first non-conductive board;
a third terminal and a fourth terminal affixed to the second non-conductive board;
a first length of fast heating, exposed high-resistance conductor having a first end affixed to the first terminal and a second end affixed to the second terminal; and
a second length of fast heating, exposed high-resistance conductor having a first end affixed to the third terminal and a second end affixed to the fourth terminal,
wherein the length of the first length of fast heating, exposed high-resistance conductor is not equal to the length of the second length of fast heating, exposed high-resistance conductor;
wherein the first length of fast heating, exposed high-resistance conductor produces a first wattage when a current is applied across the first and second terminals; and
wherein the second length of fast heating, exposed high-resistance conductor produces a second wattage when the current is applied across the third and fourth terminals.

7. The device of claim 6, wherein each of the first and second lengths of fast heating, exposed high-resistance conductor comprises one of an alloy containing about 80% nickel and about 20% chromium or an iron-chromium-aluminum alloy.

8. The device of claim 3, further comprising a third terminal affixed to the non-conductive board and the fast heating, exposed high-resistance conductor such that the fast heating, exposed high-resistance conductor has a first length and a second length,
wherein the first length extends from the first terminal to the second terminal, and the second length extends from the first terminal to the third terminal;
wherein a first wattage is produced when a current is applied across the first terminal and the second terminal; and
wherein a second wattage is produced when a current is applied across the first terminal and the third terminal.

9. The device of claim 8, further comprising a plurality of terminals affixed to the non-conductive board between the first terminal and the second terminal such that the fast heating, exposed high-resistance conductor has a plurality of lengths,
wherein a different wattage is produced when a current is applied between the first terminal and each of the plurality of terminals.

10. A heating element, comprising:
a non-conductive board;
a first terminal affixed to the non-conductive board;
a second terminal affixed to the non-conductive board;
a first length of fast heating, exposed high-resistance conductor having a first end affixed to the first terminal and a second end affixed to the second terminal;
a third terminal affixed to the non-conductive board;
a fourth terminal affixed to the non-conductive board; and
a second length of fast heating, exposed high-resistance conductor having a first end affixed to the third terminal and a second end affixed to the fourth terminal,
wherein the length of the first length of fast heating, exposed high-resistance conductor is not equal to the length of the second length of fast heating, exposed high-resistance conductor;
wherein the first length of fast heating, exposed high-resistance conductor produces a first wattage when a current is applied across the first and second terminals; and
wherein the second length of fast heating, exposed high-resistance conductor produces a second wattage when the current is applied across the third and fourth terminals.

11. The device of claim 10, wherein each of the first and second lengths of fast heating, exposed high-resistance conductor comprises one of an alloy containing about 80% nickel and about 20% chromium or an iron-chromium-aluminum alloy.

12. A heating element, comprising:
a first non-conductive board;
a second non-conductive board affixed to the first non-conductive board;
a first terminal and a second terminal affixed to the first non-conductive board;
a third terminal and a fourth terminal affixed to the second non-conductive board;
a first length of fast heating, exposed high-resistance conductor having a first end affixed to the first terminal and a second end affixed to the second terminal; and
a second length of fast heating, exposed high-resistance conductor having a first end affixed to the third terminal and a second end affixed to the fourth terminal,
wherein the length of the first length of fast heating, exposed high-resistance conductor is not equal to the length of the second length of fast heating, exposed high-resistance conductor;
wherein the first length of fast heating, exposed high-resistance conductor produces a first wattage when a current is applied across the first and second terminals; and
wherein the second length of fast heating, exposed high-resistance conductor produces a second wattage when the current is applied across the third and fourth terminals.

13. The device of claim 12, wherein each of the first and second lengths of fast heating, exposed high-resistance conductor comprises one of an alloy containing about 80% nickel and about 20% chromium or an iron-chromium-aluminum alloy.

14. The device of claim 10, further comprising a third terminal affixed to the non-conductive board and the fast heating exposed high-resistance conductor such that the fast heating, exposed high-resistance conductor has a first length and a second length,
wherein the first length extends from the first terminal to the second terminal, and the second length extends from the first terminal to the third terminal;
wherein a first wattage is produced when a current is applied across the first terminal and the second terminal; and
wherein a second wattage is produced when a current is applied across the first terminal and the third terminal.

15. The device of claim 14, further comprising a plurality of terminals affixed to the non-conductive board between the first terminal and the second terminal such that the fast heating, exposed high-resistance conductor has a plurality of lengths,
wherein a different wattage is produced when a current is applied between the first terminal and each of plurality of terminals.
